(19) United States
(12) Patent Application Publication
(10) Pub. No.: US 2009/0120944 A1
(43) Pub. Date: May 14, 2009

(54) COW BOTTLE

(75) Inventors: Aaron W. Jonas, Far Rockaway, NY (US); Thomas P. O'Brien, Bellerose, NY (US)

Correspondence Address: SCHMEISER, OLSEN & WATTS, 22 CENTURY HILL DRIVE, SUITE 302, LATHAM, NY, 12110, US

(73) Assignee: ELMHURST DAIRY, INC., Jamaica, NY (US)

(21) Appl. No.: 11/937,240

(22) Filed: Nov. 8, 2007

(51) Int. Cl. B65D 23/00; B29D 22/00

(52) U.S. Cl. 220/669; 264/132

(57) ABSTRACT

A food container configured as a decoratable figurine comprising a body configured to hold food having an opening positioned on said body to dispense food from said body. The container having a three dimensional head representation positioned on said body. The container has a cover to seal said opening and at least one item for decoration of said body that is removable and adhered onto said body. The decoratable figurine entices a child to play with the container instead of being immediately discarded leading to high brand recognition and desire to both initially purchase and repurchase product because of its secondary uses other than packaging.

### FIELD OF INVENTION

Consumer food packaging, namely food containers having decoratable figures and method of making the same.

### BACKGROUND OF THE INVENTION

Consumer food packaging has been around since there was the ability to package foods. There are several considerations when food packing is considered such as ability to maintain freshness and attractiveness to customers. Marketing studies have shown that children can play a large role in deciding if a product is bought either through direct request of a product or refusal to use an undesirable product. Therefore a marketing problem is getting notice or acceptance of a product by the child so that parents will appease or reward the child with the purchase of the desirable product.

### SUMMARY OF THE INVENTION

A first embodiment of the invention is a food container configured as a decoratable figurine comprising: a body configured to hold food; an opening positioned on said body to dispense food from said body; a three dimensional head representation positioned on said body; a cover to seal said opening; and at least one item for decoration of said body that is removable and adhered onto said body.

A second embodiment of the invention is a milk container configured as a decoratable figurine comprising: a compartment having an interior, an exterior, a top and a side, said interior configured to hold a milk based product; an opening positioned on said compartment to dispense said milk based product; a cover to close said opening; a three dimensional cow head shape positioned on said top of said exterior; and at least one item sticker on said exterior that is removable and then re-adhered onto said exterior to modify the appearance.

A third embodiment of the invention is a method of making a cow beverage figurine container comprising the steps of: providing a polymer mold configured to produce a compartment having an interior, an exterior and a side, said interior configured to hold a liquid based product, an opening positioned on said compartment to dispense said liquid based product, a three dimensional cow head shape positioned on said exterior; forming a polymer against said polymer mold to form said cow beverage figurine container; removing said cow beverage figurine container from said mold; and providing a food label with a second side that acts as a storage device having at least one item sticker, said storage device positioned on said exterior, wherein said sticker is removable from said storage device and then re-adhered onto said exterior to modify appearance.

### BRIEF DESCRIPTION OF THE DRAWINGS

The features and advantages of the present invention are illustrated in detail in the accompanying drawings, wherein like reference numerals refer to like elements throughout the drawings. Although the drawings are intended to illustrate the present invention, the drawings are not necessarily drawn to scale. The features of the present invention will best be understood from a detailed description of the invention and a preferred embodiment thereof selected for the purposes of illustration and shown in the accompanying drawings in which:

FIG. 1 illustrates a side view of the container showing the nutritional label;

FIG. 2 shows one embodiment where the sticker storage device is folded behind the nutritional label;

FIG. 3 shows another embodiment where the sticker storage device is attached to the container beneath the nutritional label that was affixed with a removable pressure sensitive adhesive;

FIG. 4 shows a side view of the stickers removed from storage device and placed upon the container for decoration by the child;

FIG. 5 shows a front view of the container;

FIG. 6A-6F shows different stickers sets for adherence to the container; and

FIG. 7A-7H shows different games that can be printed on the rear of the removable nutritional label.

### DETAILED DESCRIPTION OF THE INVENTION

Although certain preferred embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of the preferred embodiment.

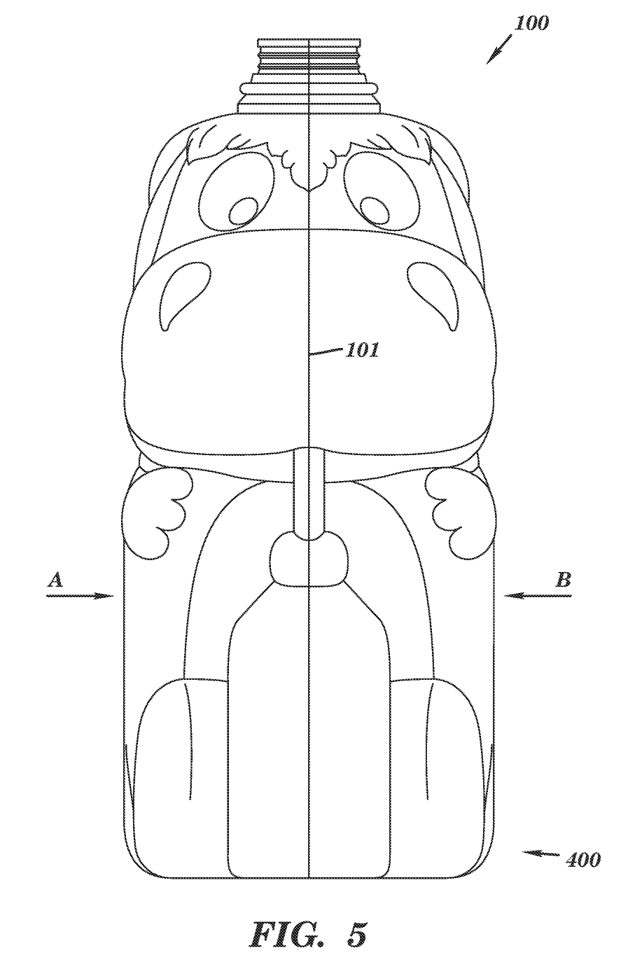

A first embodiment of the invention is a food container 100 that is configured as a decoratable figurine comprising a body 110 that is also configured to hold food. The food container 100 should be made of a material and constructed in a maimer that would satisfy any current regulatory sanitary standards based on the class of food being stored in the container 100, such as refrigerated short term storage standards for packaging or long term shelf stable non-refrigerated packaging as would be regulated by the Food and Drug Administration (FDA). The FDA regulates sealing and preparation of the food before during and after packaging, but if sanitary conditions are met the FDA is silent regarding the shape or extra functionality of a food package. The food container as shown in the front view of FIG. 5 may be made of plastic material such as an olefin selected from the group of polyethylene, polypropylene, blends of polymers thereof or multiple layers thereof. The three dimensional elements of the body 110 of the container 100 may be produced from either a continuous blow molding process, discontinuous injection blow molding, or convention injection molding of halves with sonic or frictional welding to join the halves where any process may leave a mold or welding line 101.

The food container 100 has an opening 120 positioned on said body 110 to dispense food, such as fluid milk, soy beverage, juice water or the like. The opening 120 may have various forms of approved seals 125 to maintain the required sanitary packaging standards. The opening 120 may be covered by a removable cap or cover 128 that would help to protect the contents or food within the container 100. The cap or cover 128 may be secured onto the container 100 by a snap fit closure or by engagement with threads 127 that surround the opening 120. The shelf life of the food in the container 100 and safety from tampering may be enhanced by providing a seal 125 positioned between said opening 120 and said cap 128. The container 100 may also include a handle either attached or molded integrally with the body 110 to assist in removal of the liquid beverage from the container 100.

The body 110 of the container 100 has a three-dimensional head representation 130 positioned on the top of said body 110 configured to make the container 100 appear to be a figure or doll visually. The head representation 130 may include the outlines or three-dimensional profile representation of some or all of the features that may include eyes 131, ears 134, mouth 133 and nose 135 that may be of a cartoonish character such as having an exaggerated head to body ratio that would enhance perceived appeal to a child. A doll like quality designed to attract children aged 2-10 years old to initiate play with the container 100 is the desired effect. The head 130 with some or all of the features can either be molded directly into the container 100 or it could be molded separately and later affixed to the container 100 by either mechanical interlocking or with an adhesive.

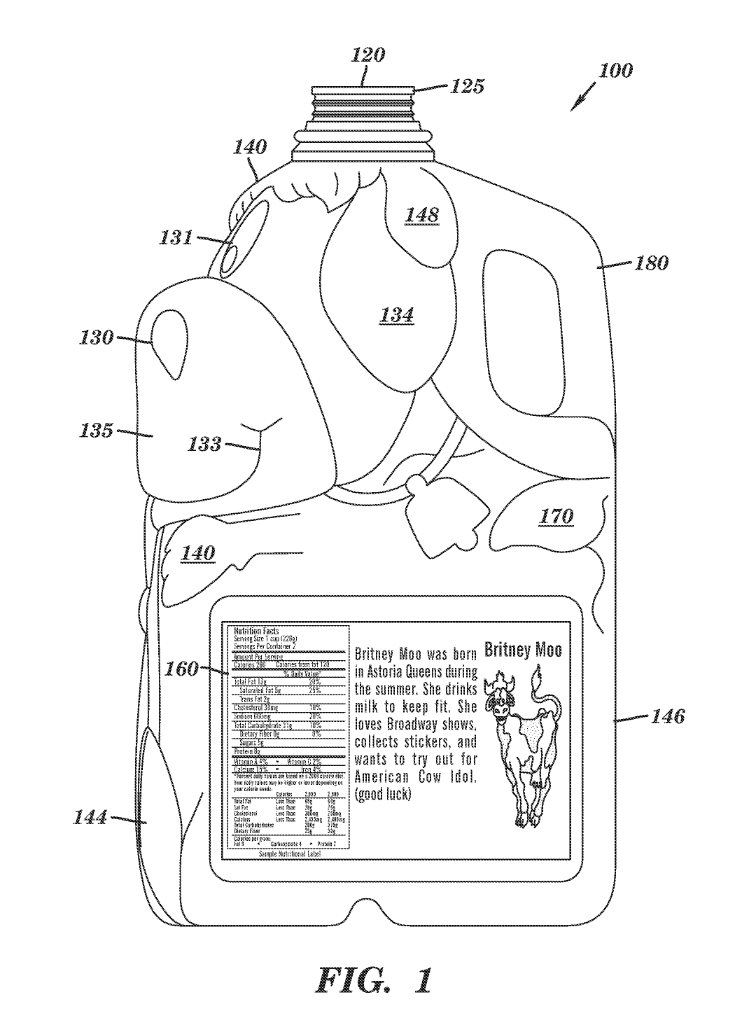

The body 110 also may have three-dimensional representations of appendages 140 that may able to be positioned on said body 110. The cow figurine may have four leg appendages 140 which could be positioned either to represent the sitting or standing of the cow figurine. The appendages 140 as shown in FIG. 1 are positioned as if the cow character 100 was in a supine position. The appendages 140 may be made smaller than proportionally normal to a real cow to emphasize cartoon features of the cow container 100 and enhance desirability to the child. The appendages 140 may be legs 142 or arms 144, tail 146, horns 148 or other protrusions 140 associated with the type of character placed on said container 100. The appendages 140 may either be fixed as shown in FIG. 1 or may be moveable by the introduction of moveable joints that are produced separately and affixed onto the body 110.

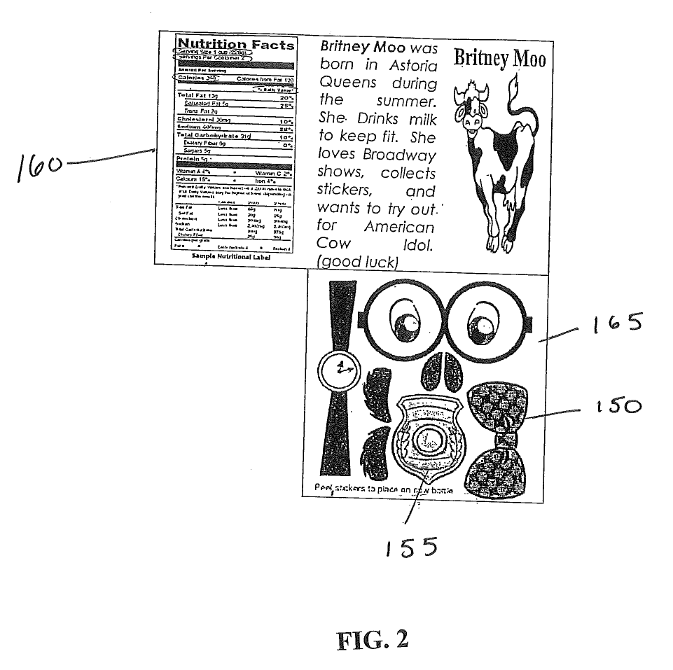

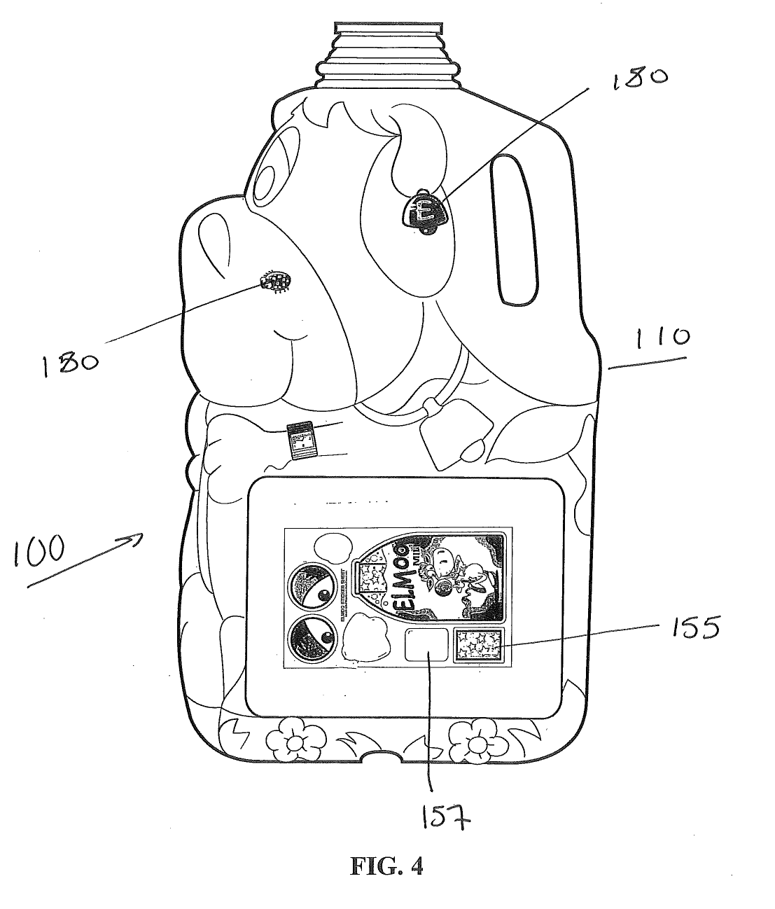

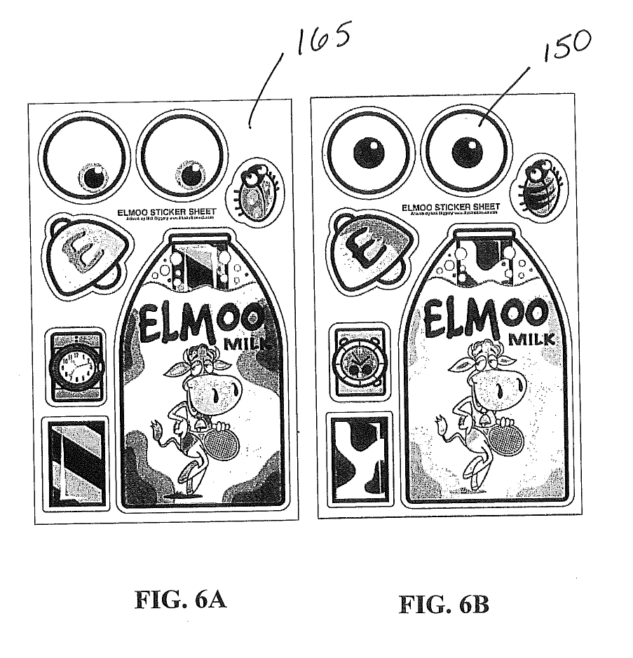

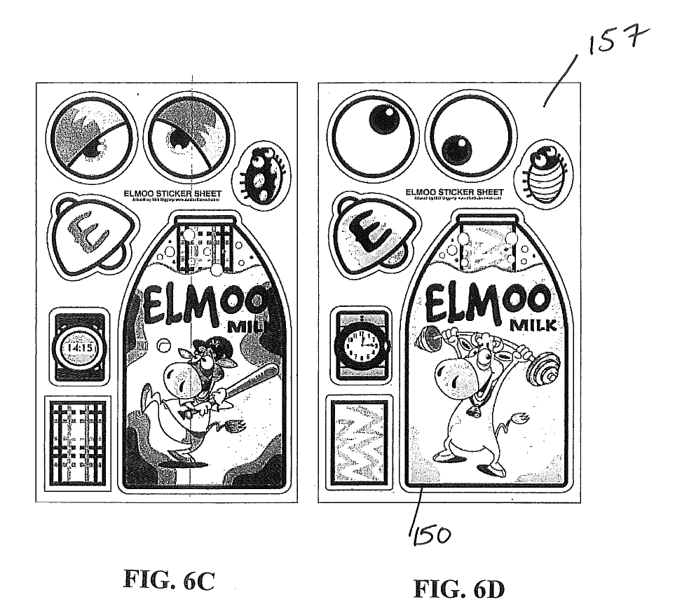

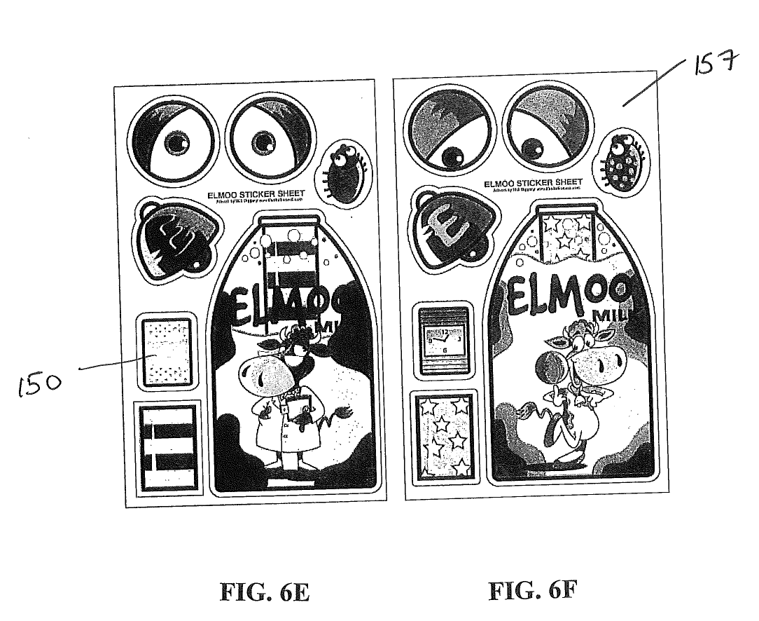

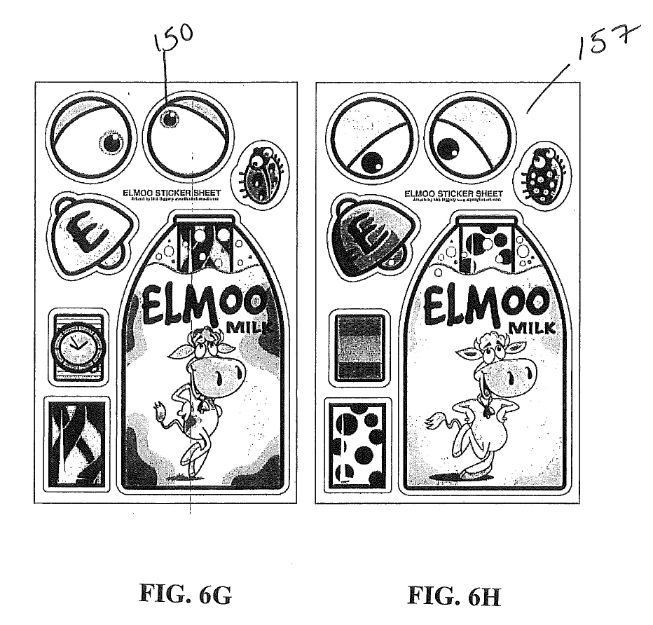

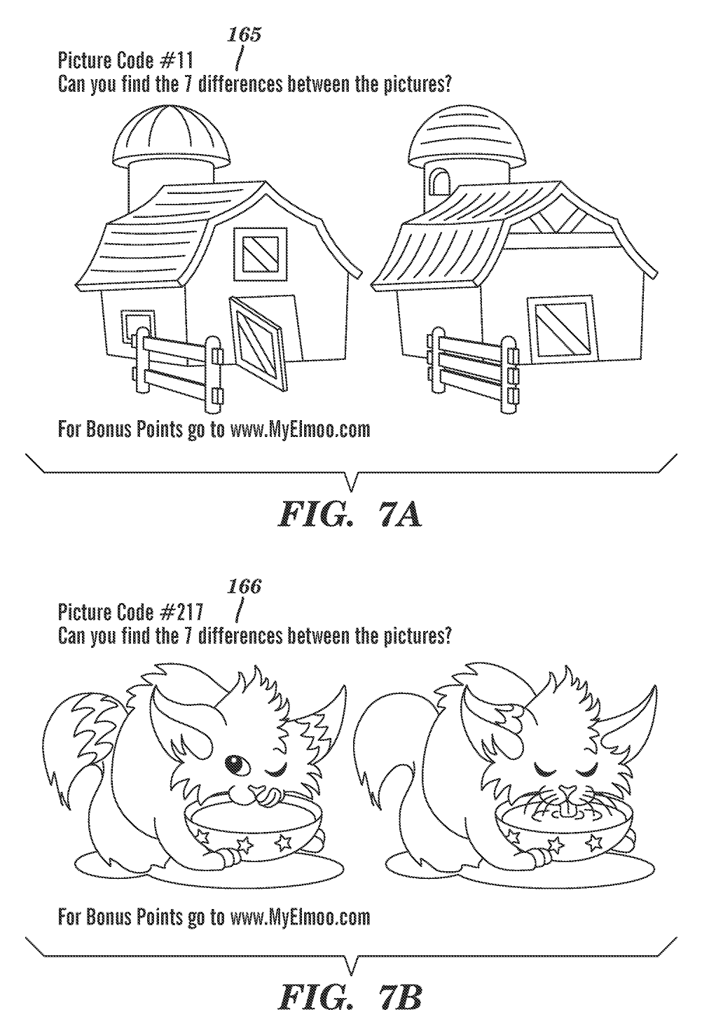

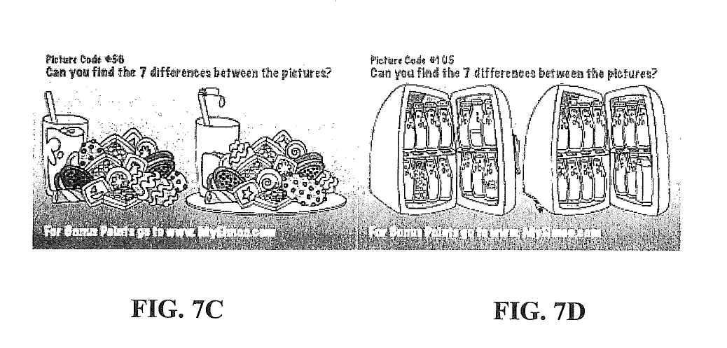

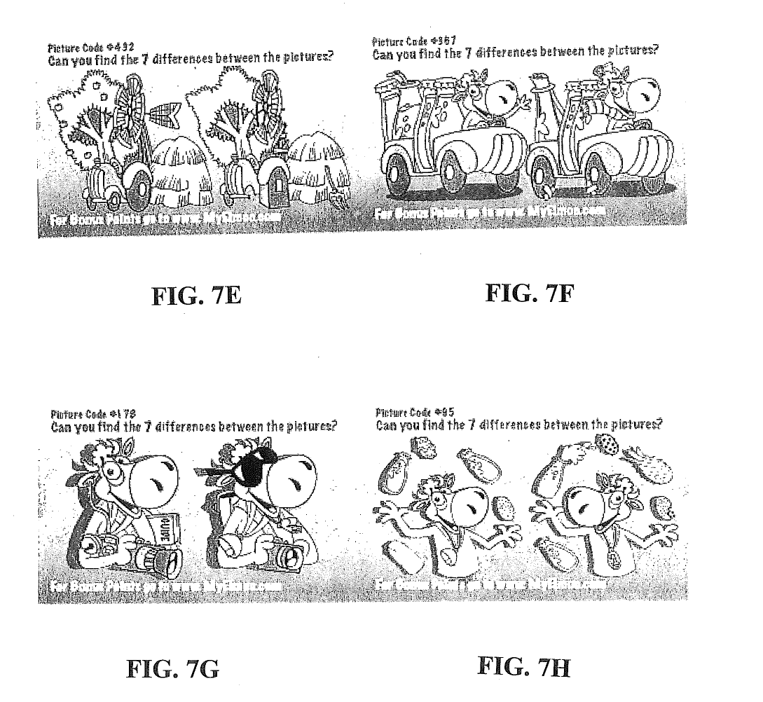

The intended user of the container 100 are children that are entertained by playing with the container 100 that is used as a cartoon fantasy character in role playing. As shown in FIG. 4, the enjoyment of the child is enhanced by having at least one item for decoration 150 of said body 110, such as a sticker 155 that may be removable from the sticker storage device 157 that may be on the container 100 either hidden beneath the or attached to the nutritional label 160. When the stickers 155 are exposed to the child by either removing a portion or all of the label 160 they are then removable from the sticker storage device 157 to be adhered onto a portion of said body 110 that is desired by the child. The item for decoration 150, as shown in FIG. 2, may instead be contained on the back 165 of the nutritional information label 160 that has the item for decoration 150 either or folded beneath the label 161 or behind the label 162. The decoration items 150 may be a paper or plastic material having a design attractive to children related to changing the appearance of a cartoonish cow character container 100. The decoration 150 may be held on by either static cling or an adhesive to keep it on the container 100. The nutritional content food label 160 may have a back face 165, wherein said label 160 is removably adhered to said body 110 and wherein said back face 165 of said nutritional content food label 150 removably contains at least one of said item for decoration 150 of said body 110. The back of the label 165 may instead include pictorial games 166 such as finding the differences between pictures as shown in FIG. 7A-7H when the affixed sticker storage device 161 is remaining on the container 100 after removal of the label 160. The item for decoration 150 may be selected from the group consisting of clothing articles, shoes, gloves, glasses, hair, mustaches, handbags, flowers and children's toys or any other fanciful item as shown in FIG. 6A-6H for affixing to the body 110 as shown in FIG. 4 according to the desires of the child.

The desirability of the container 100 to the child as an object of play may further optionally be enhanced by providing a paintable surface layer 170 covering an exterior 105 of the container 100. The paintable surface layer 170 may be created by a surface treatment 175 that removes or reacts with a portion of the surface layer that would prevent paint or colorant adhesion that may be common on many olefin plastics. The surface treatment 175 may be selected from the group consisting of flame treatment, ozone treatment, plasma treatment, and primers all of which change the surface properties of a plastic surface to make it more acceptable paint. The child would then be able to further decorate the container 100 by the use of a coloring device such as a magic marker, paint brush, crayon ink or other coloring devices known to color objects. The ability to further decorate would provide further desire for the product by the child.

The food container 100 is made into a figurine that is desired by the child for play. The ability of the child to interact with the actual food container product as a toy and entertain by the ability to decorate leads to the child being occupied. Parents would increase their likelihood of purchasing the food product if they knew their child would play with the container after use of the product as a food container 100 was finished. The duration of the product container 100 in direct contact with the parents and children are significantly increased that would lead to greater brand recognition and loyalty without resorting to expensive print or media advertising. Marketers understand that brand loyalty toward one product increases the goodwill and likelihood of buying a non-related product produced by the same manufacturer.

The food container 100 of the instant invention is different from other food products that may offer games or even stickers in that the actual food packaging product of the invention is both displayed in the store is the actual game and item to be decorated itself 180. A food product that may contain stickers for decoration, such as a cereal box may actually dissuade parental purchase as the stickers would not be placed onto the square cereal box with product logos, but onto objects within the house of the parent, but the instant invention as shown in FIG. 4 encourages decoration of the container 100 by placing relevant stickers 150 such as a watch or eyes onto the body 110. Furthermore, objects such as cereal boxes that may have pictures for painting are typically cut from the back of the package colored and then discarded whereas games 166 may be on the label 160 on the back 165 while the container 100 is still useable. Even if the game or coloring activity was retained it would be of little brand recognition value as it is devoid of the insignia that would bolster the product recognition.

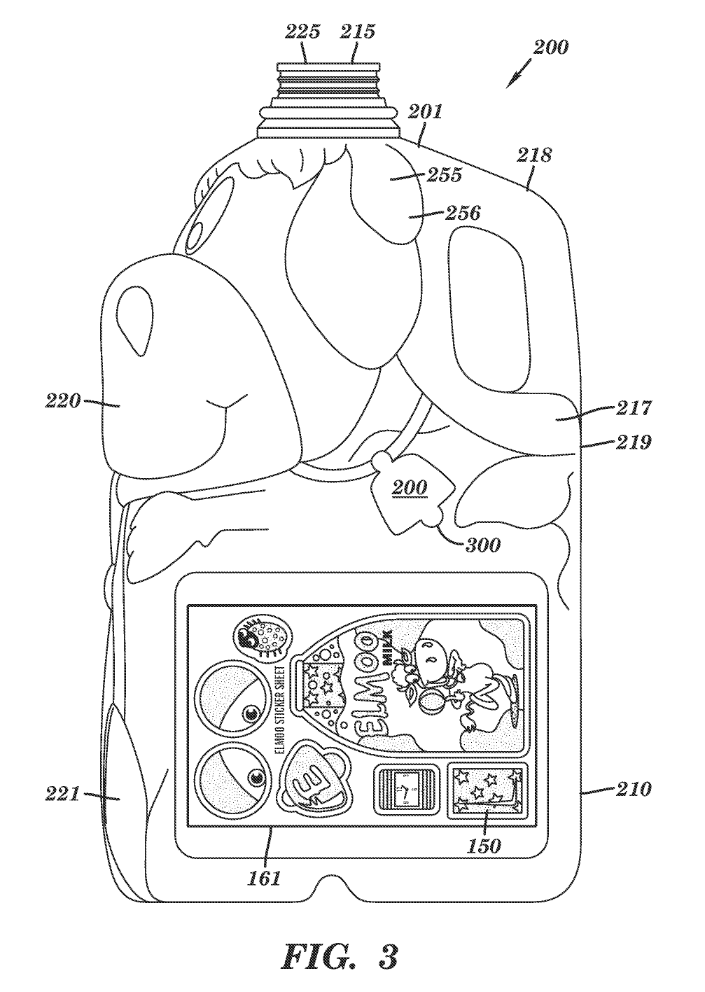

The container 100 as shown in FIG. 3, may further enhance enjoyment to the child during play optionally by the addition of a noise generator 200 simulating sounds 205 relevant to the container 100. A trigger 210 may be used to activate said noise generator 200 such as movement. The trigger 210 could be a motion detector, push button switch or microphone so that the noise generator 200 will react to the child during play. The noises generated by the noise generator 200 may be cow mooing, cow bells, songs, product advertising slogans or other sound effects. A memory chip 220 containing a plurality of sounds, wherein said sounds are reproduced by the noise generator 200 may be included along with a power source sufficient to last for several hours of play. The generation of noise electronically is well known and the noise generator 200 may be adhered to the surface of the container to mimic an item such as a bell or other protruding feature. The electronic generation of sound by disposable electronics is known to one skilled in the art currently and it is envisioned that the noise generator 200 be adherable to the container 100 and be self contained of all activation mechanisms to create sound.

Another embodiment of the milk container 200 configured as a decoratable figurine may comprise a compartment 210 having an interior 215, an exterior 216, a top 218 and a side 219, and a handle where said interior 215 is configured to hold a milk based product. As shown in FIG. 3 the milk container may be a conventionally shaped container 201 with a molded cow exterior encompassing a majority of the conventional container 201. This would allow the sterile processing of the milk based product to proceed and the decoratable figurine portion to be added after the sanitary processing of the milk was finished. Furthermore, if the cow exterior 220 surrounds and is adhered to the container 201 and is incorporated in a secondary operation it can be made of a different material having better finish qualities and brighter colors than typical milk container plastic such as high density polyethylene (HDPE) by using material such as ABS.

The container 201 has an opening 225 that is positioned on said compartment 201 to dispense said milk based product. A cover 230 is present to close said opening 225, said cover 230 may also be configured to represent a hat on top of a head. The cover 230 being shaped as a hat would serve both the function of preserving freshness and adding to the theme of an interactive child's toy.

The container 201 becomes an advertising toy by converting it to a figurine with a three dimensional cow head shape 240 is positioned on said top 218 of said exterior 220. The cow figurine exterior 220 may have at least four leg shaped protrusions 250 positioned on said exterior 220. The legs 250 may be positioned on said exterior 220 to visually appear as if standing when said compartment 201 is on said side 217. Applied to the container 201 at the rear exterior 202 is at least one item sticker 150 on said exterior that is removable and then re-adhered onto said cow exterior 220 to modify the appearance. The item sticker 150 has an appearance that may be selected from the group consisting of clothing articles, shoes, gloves, glasses, hair, mustaches, handbags, flowers and children's toys. A pair of ears 255 and horns 256 may be positioned around said opening 215. The ears 255 and horns 256 may form a loop to secure the top of the cow exterior 220 to the container 201 by catching and securing the opening 215.

The milk container 200 comprises a paintable surface layer 221 on said exterior 220 that is provided by the type of material selected such as styrene, ABS or other paintable plastic resin that can be injection molded. The plastic could have a base color white and at least one marker 260 may be provided to be used by the child to color said paintable surface layer 221. The milk container 201 may also have a base 260 positioned opposite from said top 218, wherein said base 260 may include a plurality of marker holders 265 that can include several markers 267.

The milk container 200 may also comprise a noise generator 300 that produces an audible sound 305. The noise generator 300 could be an actual bell adhered to the container 201. The noise generator 300 may be able to produce a mooing noise to simulate the sound made by a cow.

Another embodiment of the invention may include a method of making a cow beverage figurine container 200 comprising the steps of: providing a polymer mold 400 configured to produce a compartment 410 having an interior 415, an exterior 420 and a side 425, said interior 415 configured to hold a liquid based product, an opening 415 positioned on said compartment 410 to dispense said liquid based product, a three dimensional cow shape 430 positioned on said exterior 420, at least four legs shapes 440 positioned on said exterior 420. The heated polymer is then processed by forming a polymer against said polymer mold (Sides A and B) to form said cow beverage figurine container as shown in FIG. 5. This may be blow molding, thermo-forming or injection molding processes each of which forms shapes against a mold surface to form a three-dimensional product, which is the opposite of the three dimensional shapes of sides A and B of FIG. 5.

After the molding of the three dimensional features are done next is removing said cow beverage figurine container 100 from said mold 400. Finish the cow figurine container 100 by providing a food label 160 with a second side that acts as a storage device having at least one item sticker 150, said storage device positioned on said exterior, wherein said sticker 150 is removable from said storage device 160 and then re-adhered onto said exterior to modify appearance.

The method of making a cow beverage figurine container 100 may further comprise the step of surface treating said exterior 120 of said cow beverage figurine container 100 after removal from said mold and before application of said storage device 160. This surface treatment may allow the providing at least one marker to color said surface of said container.

Another embodiment of the invention is a method of using a decoratable figurine food storage container 100 comprising the steps of providing said decoratable figurine food storage container comprising an interior to contain food and an exterior configured with three dimensional features to resemble a toy having at least one item for decoration attached to said container on a storage device. The child then interacts with the product by removing said at least one item for decoration from said storage device and decorating said decoratable figurine food storage container by placing said at least one item for decoration onto an exterior surface of said container.

The child can be enticed to further interact with the container by providing a paintable exterior on said container and at least one painting apparatus. The coloring of at least a portion of said exterior with said at least one painting apparatus causes the child to convert the container into an individualized creation. This creativity would likely be supported by parents and rewarded by prominently displaying the decorated container leading to high brand and character recognition and likelihood of purchasing the product again by the parent thus serving a dual purpose of both storing the product and enhancing advertisement of the product.

Various modifications and variations of the described apparatus and methods of the invention will be apparent to those skilled in the art without departing from the scope and spirit of the invention. Although the invention has been described in connection with specific embodiments, outlined above, it should be understood that the invention should not be unduly limited to such specific embodiments. Various changes may be made without departing from the spirit and scope of the invention as defined in the following claims.

What is claimed is:

1. A food container configured as a decoratable figurine comprising:
a body configured to hold food;
an opening positioned on said body to dispense food from said body;
a three dimensional head representation positioned on said body;
a cover to seal said opening; and
at least one item for decoration of said body that is removable and adhered onto said body.

2. The container of claim 1 further comprising:
a nutritional content food label having a back face, wherein said label is removably adhered to said body and wherein said back face of said nutritional content food label removably contains at least one of said item for decoration of said body.

3. The container of claim 1 further comprising:
a seal positioned between said opening and said cap, and wherein said food is shelf stable.

4. The container of claim 1 further comprising:
a paintable surface layer covering an exterior of the container.

5. The container of claim 1 further comprising:
a noise generator simulating sounds relevant to the container.

6. The container of claim 5 further comprising:
a trigger to activate said noise generator.

7. The container of claim 6 further comprising:
a memory chip containing a plurality of sounds, wherein said sounds are reproduced by the noise generator.

8. The container of claim 1 wherein the item for decoration is selected from the group consisting of clothing articles, shoes, gloves, glasses, hair, mustaches, handbags, flowers and children's toys.

9. The container of claim 4 wherein the paintable surface layer is created by a surface treatment.

10. The container of claim 9 wherein the surface treatment is selected from the group consisting of flame treatment, ozone treatment, plasma treatment, and primers.

11. The container of claim 1 further comprising:
at least four appendages positioned on said body; and
a tail shaped protrusion positioned on said body opposite from said top.

12. A milk container configured as a decoratable figurine comprising:
a compartment having an interior, an exterior, a top and a side, said interior configured to hold a milk based product;
an opening positioned on said compartment to dispense said milk based product;
a cover to close said opening;
a three dimensional cow head shape positioned on said top of said exterior; and
at least one item sticker on said exterior that is removable and then re-adhered onto said exterior to modify the appearance.

13. The milk container of claim 12 further comprising:
a paintable surface layer on said exterior; and
at least one marker to color said paintable surface layer.

14. The milk container of claim 13 further comprising:
a base positioned opposite from said top, wherein said base includes a plurality of marker holders.

15. The milk container of claim 12 further comprising:
at least four leg shaped protrusions positioned on said exterior, said legs positioned on said exterior to visually appear as if standing when said compartment is on said side; and
a pair of ears positioned around said opening.

16. The milk container of claim 12 further comprising:
a noise generator that produces an audible sound.

17. The milk container of claim 12 wherein the item sticker has an appearance that is selected from the group consisting of clothing articles, shoes, gloves, glasses, hair, mustaches, handbags, flowers and children's toys.

18. A method of making a cow beverage figurine container comprising the steps of:
providing a polymer mold configured to produce a compartment having an interior, an exterior and a side, said interior configured to hold a liquid based product, an opening positioned on said compartment to dispense said liquid based product, a three dimensional cow head shape positioned on said exterior;
forming a polymer against said polymer mold to form said cow beverage figurine container;
removing said cow beverage figurine container from said mold; and
providing a food label with a second side that acts as a storage device having at least one item sticker, said storage device positioned on said exterior, wherein said sticker is removable from said storage device and then re-adhered onto said exterior to modify appearance.

19. The method of making a cow beverage figurine container of claim 18 further comprising the steps of:
surface treating said exterior of said cow beverage figurine container after removal from said mold and before application of said storage device.

20. The method of making a cow beverage figurine container of claim 19 further comprising the steps of:
providing at least one marker to color said surface of said container.

21. A method of using a decoratable figurine food storage container comprising the steps of:
providing said decoratable figurine food storage container comprising an interior to contain food and an exterior configured with three dimensional features to resemble a toy having at least one item for decoration attached to said container on a storage device;
removing said at least one item for decoration from said storage device; and
decorating said decoratable figurine food storage container by placing said at least one item for decoration onto an exterior surface of said container.

22. The method of claim 21 further comprising the steps of:
providing a paintable exterior of said container and at least one painting apparatus; and
coloring at least a portion of said exterior with said at least one painting apparatus.
